(19) United States
(12) Patent Application Publication
(10) Pub. No.: US 2008/0163314 A1
(43) Pub. Date: Jul. 3, 2008

(54) Advanced information display method

(76) Inventors: Lang Lin, Potomac, MD (US); Wang Su, East Patchogue, NY (US)

Correspondence Address: Wang Su, 154 Donegan Ave., East Patchogue, NY, 11772, US

(21) Appl. No.: 11/894,301

(22) Filed: Aug. 22, 2007

Related U.S. Application Data
(63) Continuation-in-part of application No. 11/647,010, filed on Dec. 28, 2006.

(51) Int. Cl. H04N 7/173

(52) U.S. Cl. 725/98

(57) ABSTRACT

An advanced information display method is disclosed wherein a first video having at least an image of a first element is presented, the tracking information of the first element in the first video is obtained, a second video having at least an image of the first element is obtained, the images of a second element which bears certain information to be displayed are also presented, and the images of the second element are added to the second video based on the tracking information.

This application is a continuation-in-part of pending application Ser. No. 11/647,010, filed Dec. 28, 2006.

### BACKGROUND OF THE INVENTION

Information can be expressed in many forms, such as images, articles, descriptions, numbers, advertisements, etc. These forms of information can be carried on different mediums, such as paper and electronic display devices. Presently, information is mostly presented in a way that its position is rather restricted, such as an article printed on a news paper or a picture shown on a page of a particular website. Sometimes, information is presented in a manner that allows certain movement, especially on electronic media, such as floating icons used on some internet websites, or a moving advertisement that follows the cursor. However, these methods of displaying information do not present a way to dynamically display information so as to reflect the interconnection among different image elements in a video.

Presently, vendors of video services typically produce compressed video sequences based on some higher quality video sources. The compressed video sequences subsequently are delivered through a communication network to a group of end users for viewing on certain devices. The communication network can be either traditional broadcasting networks (over the air or cable network), or any data networks (internet or mobile network or home network), or the emerging peer to peer networks, or the combinations of them. The devices that end users use for viewing the produced video sequences have displays of different designs or sizes, such as large screen televisions found at consumers' homes, or small liquid crystal displays (LCD) used on mobile phones as well as any portable video/multimedia devices. End users are often people without any knowledge on video processing.

Current video processing methods and systems are usually designed under a one-size-fits-all principal that produce one set of main video for different viewing devices, allowing little control by end users in processing and displaying video signals. For example, when watching television at home, no matter what kind of television the user has, he or she always gets the same video sequence for displaying on the television. The user only has some very limited choices as to how the video is to be displayed, such as whether to add subtitles or not, or whether to display a smaller picture within a larger picture or not, commonly referred to as picture in picture. Other than that, not many meaningful video adjustments are available to the end users. Such a one-size-fits-all model often needs to satisfy a minimum quality requirement while minimizing both the bandwidth in delivering video sequences over networks and the system complexity on the devices that receives and/or displays video sequences. Although the one-size-fits-all model is convenient for the service providers, but it may not be able to offer satisfying viewing experience to all users because the very significant differences existing among the viewing devices of the users.

There is another challenge associated with current video processing method, which is when processing videos containing small objects, and delivering such processed video sequences to a small screen for display, the small objects often become hard to discern, sometimes even totally disappear. This can happen when broadcasting either baseball or tennis matches to a mobile phone that can display video sequences on a small LCD screen. A typical baseball has a diameter under 3 inches and a typical baseball field has 90 feet between adjacent bases. If a pixel is used to display a baseball, it requires more than 360 pixels to display adjacent bases. For any video sequences with less resolution, the baseball can disappear during either the compression or the transcoding or the transcaling process. In addition, even if a high resolution format and high resolotuion video display device is chosen which can allocate more pixels to the baseball, the baseball may still be less than 0.5% of an inch on a small screen which will make it hard to see with a naked eye at a normal distance.

Therefore, there is clearly a need for an improved video processing method and system to address these challenges and dynamically display information to reflect the interconnection of different image elements of a video.

### BRIEF DESCRIPTION OF THE DRAWINGS

FIG. 1 illustrates an image frame of a parent video sequence;

FIG. 2 illustrates an image frame corresponding to the image frame as shown in FIG. 1 but after compression where certain critical image element has been lost;

FIG. 3 illustrates an image frame corresponding to the image flame as shown in FIG. 1 but processed with the improved video processing method described in the current invention where certain critical image element is preserved;

FIG. 4 is a flow chart showing illustrative steps that may be followed to perform the improved video processing method in accordance with one embodiment of the invention;

FIG. 5 is a flow chart showing illustrative steps that may be followed to perform the improved video processing method in accordance with another embodiment of the invention;

FIG. 6 is a schematic diagram showing an illustrative system that may be used in conjunction with an embodiment of this invention.

FIG. 7 illustrates a video wherein an information box is added to the video at a position correlated to an element already present in the video.

### DETAILED DESCRIPTION OF POSSIBLE EMBODIMENTS OF THE INVENTION

Possible embodiments of the invention are discussed in this section.

To deliver quality video services over heterogeneous networks to various display devices is a serious challenge for deploying new video services. Objectively, the service providers would want to reduce the communication bandwidth requirement dramatically while maintaining a minimum quality requirement by adopting new video standards, such as MPEG4 and H.264. However, the same kind of video processing, compressing method will cause drastically different results depending on the kind of the image that is being transmitted.

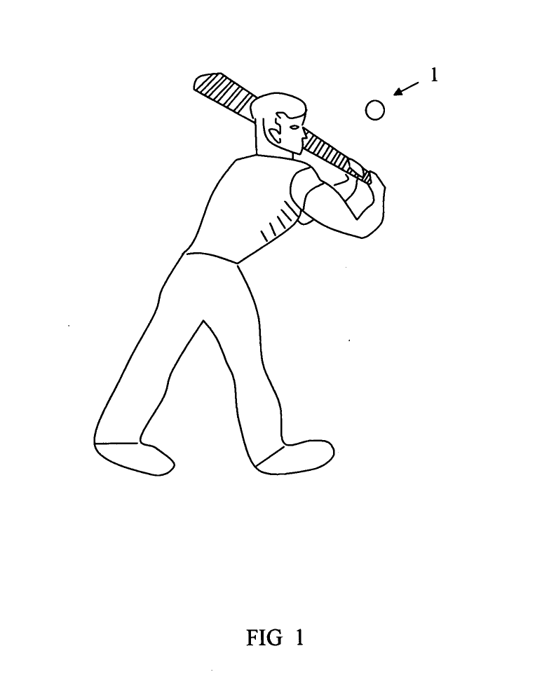

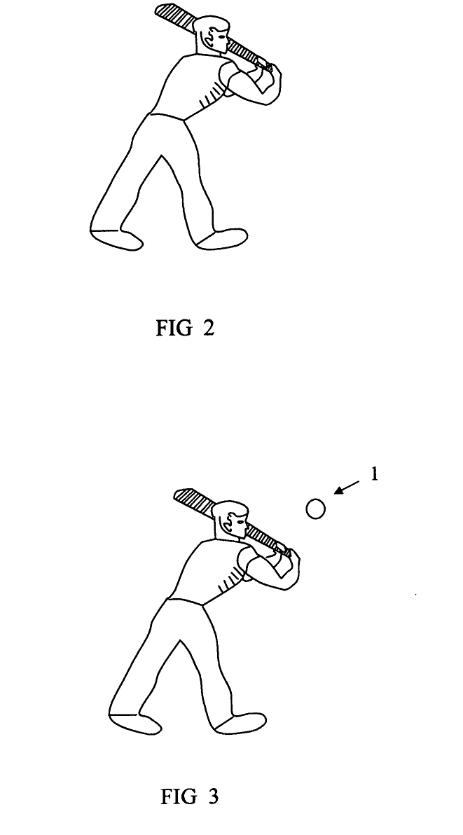

For example, FIG. 1 illustrates an image frame of a parent video sequence where the critical image element, which is ball 1 in this case, is preserved and is clearly visible. FIG. 2 illustrates an image frame corresponding to the image frame as shown in FIG. 1, but after compression and downsizing, and the critical image element ball 1 is no longer visible. According to this frame of image, instead of being about to hit the ball 1, the player seems to be just waiting for the ball 1 to come. FIG. 3 further illustrates an image frame corresponding to the image frame as shown in FIG. 1, but processed with the improved video processing method described in the current invention, where the critical image element ball 1 is preserved and visible. As a result, instead of just waiting for the ball 1 to come, the player is back in action again.

According to one embodiment of the invention, one of the higher quality video files, before it is preprocessed for broadcasting, when critical image elements are still clearly viewable or traceable, we call this video file the master copy, or the parent video. After the parent video is processed at least once, we call the resulted video file the child video. After the child video is processed at least once, we call the resulted video file the grandchild video. After the grandchild video is processed at least once, we call the resulted video file the great grandchild video.

The parent video usually has a lot of details including those that are essential to the theme of the video. However, parent videos are often very large in size and therefore difficult to be delivered over a bandwidth limited network. Processing the parent video into a child video to reduce the video size as well as the video resolution often involves compression or transcoding or transcaling. This processing step introduces the possibility that a critical image element may get lost.

According to one embodiment of the invention, a generic method is employed to obtain the information of the critical image element. The information may include the horizontal and vertical positions of the critical image element in the various image frames of the parent video, the size of the critical image element, the contour of the critical image element, the color, brightness, etc. The information can be obtained using any video object acquiring/tracking system available today, such as those discussed in articles “A Scheme for Ball Detection and Tracking in Broadcast Soccer Video”, by Dawei Liang, Yang Liu, Qingming Huang, and Wen Gao, published on the 6th Pacific-Rim Conference on Multimedia, Jeju Island, Korea, pp 864-875, Nov. 13-16, 2005, and “Preprocessing of Ball Game Video Sequences for Robust Transmission Over Mobile Network”, by Olivia Nemethova, Martin Zahumensky, Markus Rupp, and Tu Wien, published on CDMA International Conference, Seoul, Korea; October 25-28, 2004. The first publication, “A Scheme for Ball Detection and Tracking in Broadcast Soccer Video”, describes a method for both detecting the ball in a ball game and tracking the ball in a sequence of video frames of a ballgame video. Multiple video flames are utilized for performing the functions. When detecting the ball, this scheme uses color, shape and size for extracting ball candidates in each flame, and compares the information in adjacent frames. Viterbi algorithm is applied to extract the path that is likely to be the ball's path. After the ball is detected, Kalman filter and template matching are used to track ball location. Ball location information is constantly updated during the tracking step for possible ball re-detection. The second publication, “Preprocessing of Ball Game Video Sequences for Robust Transmission Over Mobile Network”, describes a different method for tracking a ball using trajectory knowledge, position prediction, and the sum of absolute differences counting. These image element detecting and tracking methods, as well as other detecting and tracking methods available currently, can be used to perform the tracking step of this invention to find and track the location of the critical image element in the image frames of the parent video.

According to one embodiment of the invention, once the information of a critical image element is obtained from the parent video, the parent video is then processed by a compression method to produce the child video so as to reduce video file size for transmission over a network. The compression methods that can be used include standard methods such as H.264, MPEG 4, and VC-1. In some situations, a parallel camera can be used in conjunction with the main camera to produce a low resolution video at the same time when a high resolution parent video is produced. If such low resolution video has the same content as the high resolution parent video but at a much smaller size, it can be used as a child video as well.

Once the child video is obtained, according to one embodiment of the invention, a grant child video is produced by reconstructing the critical image element onto the child video using the information of the critical element produced from the parent video. To perform this function, certain information needs to be adjusted. Some of the adjustments are done based on a comparative relationship between the parent video and the child video. For example, the horizontal and vertical positions of the critical image element in the various image frames of the parent video need to be adjusted to place the critical image element in the same locations of the corresponding image frames of the child video based on a comparison of the horizontal and vertical sizes of the corresponding image frames of the parent video and the child video. This may be done by adding a factor to the numbers representing horizontal and vertical positions, and the factor corresponds to the compression ratio of the child video. For example, if the size of the images frame in the child video is reduced by half both horizontally and vertically, then the number representing the horizontal and vertical positions of the critical image element in the image frames of the parent video can be both reduced by half accordingly. Other factors can also be introduced to adjust other tracking information for the critical image element relating to size, contour, color, brightness, etc. Some of these factors can be arbitrarily decided by the producer of the child video. After the tracking information for the critical image element is adjusted with the factors as exemplarily explained in the above, the adjusted tracking information is then employed to reconstruct the critical image element onto the child video so as to produce the grandchild video. The critical image element can be reconstructed onto the child video using the adjusted tracking information by various methods. It can be simply redrawn to the various image frames of the child video using the tracking information or can be blended into the child video using alpha blending. Alpha blending is a commonly used imaging processing method for the purpose of combing multiple layers of image frames with various degrees of opacity. If the tracking information contains only the position information of the critical image element, the tracking information can be multiplexed with the child video for transmission purposes using any standard multiplexing methods. More than one critical image elements can be processed following the same method. When multiple critical image elements are involved, they can be distinguished either by their different characteristics such as shape, size, color, brightness, etc., or by their respective trajectory paths, or the combination of both. Some of the imaging processing methods can be in compliance with international standards such as H.264, MPEG4, or VC-1.

In a H.264 environment for example, the reconstruction of the critical image element onto the child video using the adjusted tracking information extracted from the parent video can be conducted through one or more of the following steps.

According to the H.264 standard, alpha blending is performed using an auxiliary coded picture and a primary coded picture. The auxiliary coded picture is an auxiliary component of the image video, and the support for the auxiliary coded picture is optional. The primary coded picture may have a background picture and a foreground picture. Both the foreground picture and the auxiliary coded picture are suitable for carrying tracking information related to the critical image element. Section 7.4.2 of the March 2005 H.264 specification prepublication, which is hereby incorporated by reference, details how to perform alpha blending so as to reconstruct the critical image element onto the child video to produce the grandchild video. For illustrative purposes, we use a baseball game video as an example. The critical image element in this video is the baseball.

First, the spatial and temporal information of the critical image element, the baseball, is obtained from a high quality baseball game video, the parent video. The parent video is compressed using the H.264 standard to generate the child video. The child video has the primary coded picture, which can be either one sequence of video pictures, or two related sequences of video pictures comprising the background picture and the foreground picture. A separate auxiliary coded picture may also be generated based on the producer's preference.

Then, the tracking information of the critical image element (the baseball), such as the spatial and temporal information of the baseball, is marked in the frames of either the foreground picture of the primary coded picture, or the auxiliary coded picture, or both. Such marking can be done for example by simply drawing the baseball to the foreground picture or the auxiliary coded picture using the tracking information.

In one situation, the tracking information of the critical image element only contains the center of the baseball. In this case, it may be that only the pixel in the center of the ball is marked in the foreground picture or the auxiliary coded picture using the tracking information.

In another possible situation, the tracking information of the critical image element may include the contour of the baseball in addition to the center. In this case, a larger region may be marked in the foreground picture or the auxiliary coded picture corresponding to the baseball using the tracking information. The tracking information may be adjusted tracking information as discussed earlier.

After the foreground picture or the auxiliary coded picture is marked with the tracking information, the primary coded picture, in this case the core of the child video, is delivered to end user, as well as the auxiliary coded picture if it is generated. The tracking information of the critical image element has been embedded into either the foreground picture or the auxiliary coded picture, or both. Because the generation and transmission process is in compliance with the H.264 standard, any H.264 compliant device can display the sequence. Since the support for auxiliary coded picture is optional under H.264, in the situation that the producer generates an auxiliary coded picture for carrying the critical image element tracking information, the producer can send an instruction to the end user device alerting it to process the auxiliary coded picture.

Once the end user device receives the primary coded picture and the auxiliary coded picture, it can then generate the grandchild video by performing alpha blending as described in section 7.4.2.1.2 of the March 2005 R264 specification prepublication. If the auxiliary coded picture is not generated and the tracking information is carried by drawing the critical image element to the foreground picture of the primary coded picture, alpha blending can be performed between the foreground picture and the background picture of the primary coded picture.

In a MPEG4 environment, similar process can be followed. MPEG4 also supports alpha blending. A difference between MPEG4 and H.265 is that in MPEG4 there is no primary coded picture and auxiliary coded picture. Instead, video objects are coded into video object planes (VOPs), and the grayscale shape information can be an auxiliary component of a VOP. Consequently, multiple VOPs can be used as the background picture, the foreground picture and the auxiliary coded picture, respectively. The critical image element tracking information can be carried by the VOPs that contain similar image information as the foreground pictures or auxiliary coded pictures in a H.264 environment. The tracking information can be preserved by drawing images onto the VOPs basing on the tracking information. A grandchild video can be generated by performing alpha blending using these VOPs similar to performing alpha blending using primary coded pictures and auxiliary coded pictures in a H.264 environment

Moreover, since a VOP in a MPEG4 environment can carry grayscale shape information, each frame of the child video can be represented by just one VCP. The tracking information of the critical image element can be incorporated into an auxiliary component of the VOP such as the grayscale shape information. Section 7.5.5 of the International Standard ISO/IEC 14496-2, Second Edition, is a detailed introduction of the grayscale shape information and how to carry image information with grayscale shape information, which is hereby incorporated into this specification by reference. A grandchild video can be generated by reconstructing the critical image element onto the child video using the tracking information contained in the grayscale shape information. This is particularly useful for a low profile MPEG4 video and other videos that have similar structures.

It is noted that the above described processes are just some examples. The current invention does not have to comply with international standards, and if it does, it can introduce variations. For example, when the tracking information contains only the center position of the critical image element, the service provider can send a pattern to go along with the child video, or the pattern can be pre-stored on the user end device. The grandchild video can be generated with the pattern together with the primary coded video, the auxiliary coded video, or the VOPs, placing the pattern at or near the center position of the critical image element. Furthermore, user inputs can be solicited by the user end device to determine the characteristics of the pattern, such as its size, color, brightness, etc. If the tracking information for the critical image element contains information such as the size, contour, color, brightness, etc. of the critical image element, user inputs can also be solicited by the user end device to change such characters before generating the grandchild video.

The above described processes can be extended to the scenario where there are more than one critical image element, because there is no limit on how many items can be shown on the foreground picture, the auxiliary coded picture, or the VOP. It is generally possible to code many image elements on the foreground picture, the auxiliary coded picture or the VOPs. These image elements can be differentiated by such characters as color, shape, and location.

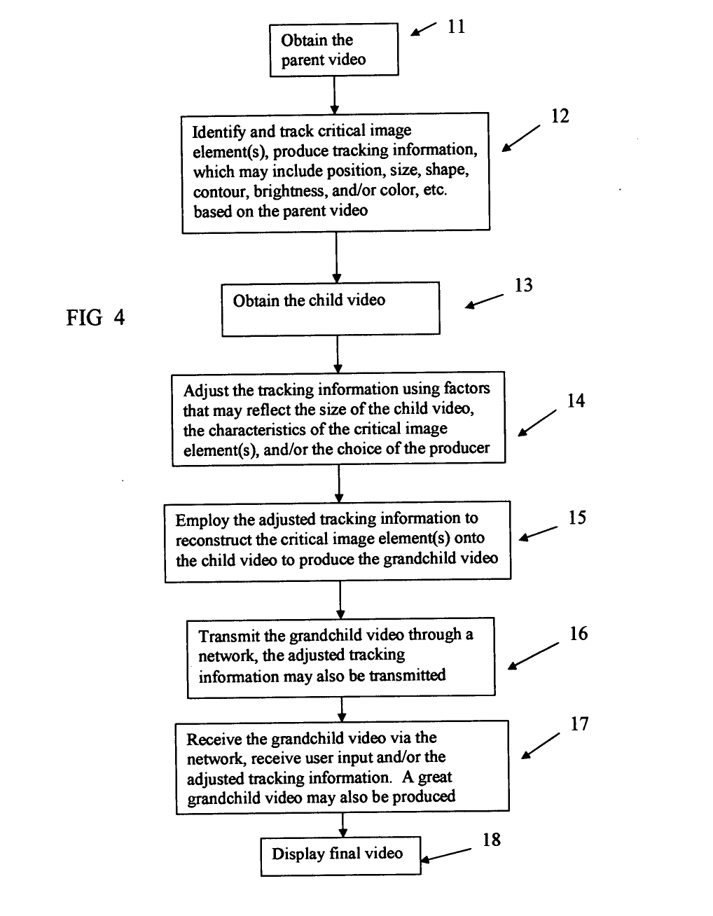

FIG. 4 is a flow chart showing illustrative steps that may be followed to perform the improved video processing method in accordance with one embodiment of the invention. A parent video file containing a critical image element, or multiple critical image elements are first obtained. Then, at step 12, the critical image element(s) are detected and tracked using known detecting and tracking methods including those described above to produce tracking information from the patent video. Either before or after tracking information is obtained, at step 13, the child video is obtained by, for example, compressing the parent video using one of the known image processing methods, such as H.264, MPEG 4, or VC-1. At step 14, the tracking information is adjusted based on factors such as the compression ratio, the characteristics of the critical image element(s), and the choice of the producer. The adjusted tracking information is then employed at step 15 to reconstruct the critical image element onto the child video to produce the grandchild video. The grandchild video is then broadcasted through a broadcasting network. According to one embodiment of the invention, the adjusted tracking information is broadcasted together with the grandchild video. The tracking information or adjusted tracking information can be embedded in a subset of image frames of the child video or grandchild video. The embedment can be achieved by drawing a series of images onto the subset image frames that utilize and reflect the tracking information. According to another embodiment of the invention, an identifier may be added to the adjusted tracking information to identify that this tracking information is related to at least one of the parent video, the child video, and the grandchild video. The identifier can be an electronic code with binary digits. At step 17, the user end displaying device receives the grandchild video. If the adjusted tracking information is also broadcasted, the user end displaying device may pick up the adjusted tracking information as well. User inputs can be received at the user end displaying device. According to different embodiments of the present invention, the grandchild video may be displayed directly or a great grandchild video may be produced based on the user input, the adjusted tracking information and the grandchild video.

The user input may be received through any comment input hardware and software devices, such as infrared receivers for remote controls, or input keys on the user end displaying device. User inputs may be used as an additional set of factors for further adjusting the adjusted tracking information, for example size, color, brightness, etc. of the critical image element(s). User inputs may also be used for retrieving and adjusting pre-stored image patterns to be used as a replacement of the critical image element(s). For example, if the tracking information consists only the position of the center of a critical image element such as a baseball, then a circular image pattern can be pre-stored. The pre-stored image pattern can then be used to reconstruct the critical image element onto the main video by placing it at the center positions contained in the tracking information. User inputs can be used to retrieve such pre-stored image pattern and make changes to its size, color, brightness, etc. Alpha blending is one of the many possible ways of achieving such reconstruction. A great grandchild video can be produced by reconstructing the critical image element(s) onto the grandchild video employing the further adjusted tracking information. The great grandchild video is then displayed for the end user.

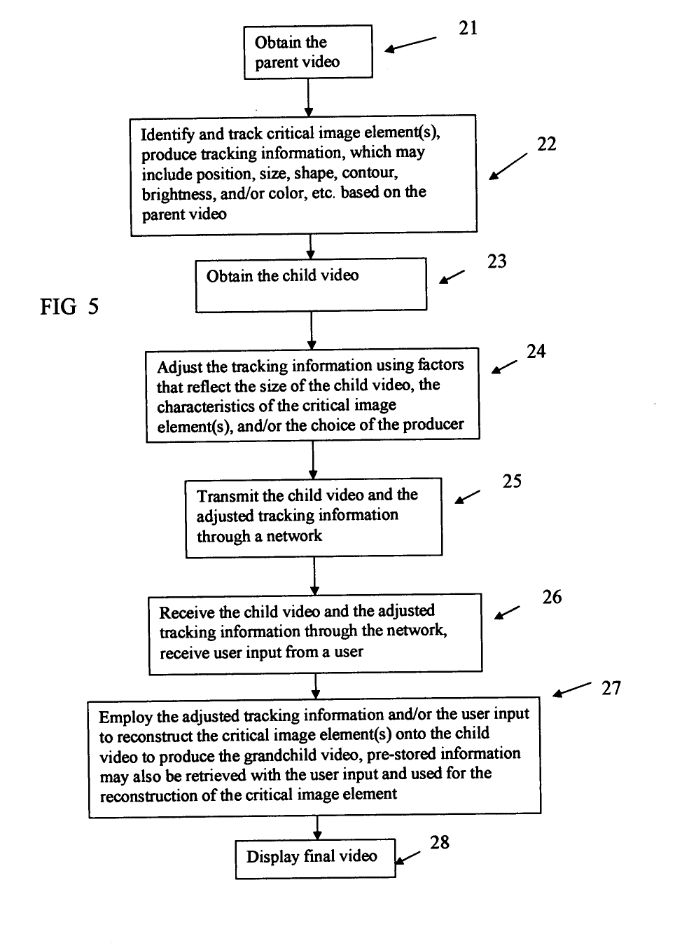

FIG. 5 is a flow chart showing illustrative steps that may be followed to perform the improved video processing method in accordance with another embodiment of the invention. According to this embodiment, tracking information of critical image element(s) is obtained from the parent video during step 22 using methods described above. Either before or after tracking information is obtained, at step 23, a child video is obtained by for example compressing the parent video. At step 24, the tracking information is adjusted by various factors similar to those described in FIG. 4. The child video and the adjusted tracking information are then sent to end users through a broadcasting network. The tracking information or adjusted tracking information can be sent separate from the child video or can be embedded in a subset of image frames of the child video. If it is sent separate from the child video, an identifier can be added to the adjusted tracking information to identify that it is related to the child video. According to other embodiments not described in these drawings, the adjustment of the tracking information can be reserved for the end user device, and the original tracking information can be sent along with the child video. The user device receives the original tracking information or the adjusted tracking information and the child video from the network at step 26. The original tracking information can be adjusted at this step in a similar way as described earlier. The adjusted tracking information can be employed to reconstruct the critical image element(s) to produce the grandchild video. User inputs can be used as additional factors to further adjust the adjusted tracking information for the reconstruction of the critical image element(s) during the production of the grandchild video. If the tracking information is sent separate from the child video, the identifier can be used to associate the tracking information with the child video and the critical image element can be redrawn to the child video using the tracking information. If the tracking information is embedded into a subset of image frames of the child video, then the subset of image frames can be used directly to reconstruct the critical image element onto the child video through alpha blending, or, any standard finding and tracking methods can be employed to retrieve tracking information from these subset of image frames, and critical image element can be redrawn to the child video using the retrieved tracking information. Similar to the processes discussed in the previous paragraph, a pre-stored image pattern can be used in the reconstruction of the critical image element, and user inputs can also be used in conjunction with the pre-stored image pattern. The final video file is then displayed by the display device at step 28.

Alternatively, following similar processes as discussed above, the tracking information or adjusted tracking information and user inputs can be used to reconstruct the critical image element(s) onto an independent set of image frames rather than onto the image frames of the child video. Then, the independent set of image frames and the image frames of the child video are displayed separately but in such a sequence and speed that they are visually blended in the eyes of the viewers. Some image frames of the independent set of image frames would be displayed in between some of the image frames of the child video.

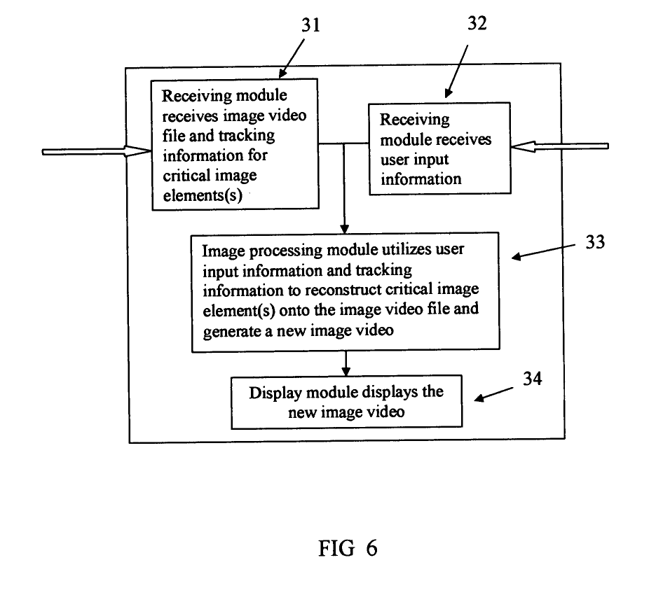

FIG. 6 is a schematic diagram showing an illustrative system that may be used in conjunction with an embodiment of this invention. This device or system, which can be placed either in one housing or multiple housings connected electronically, has different functional modules, which can be hardware or software modules, for performing the functions as shown in the diagram. Module 31 is the module that receives image video file and tracking information from the broadcasting network. This module can comprise any hardware, such as an antenna or a modem, or software that can be used for receiving broadcasting signals from a wired or wireless network. The image video file can be a parent video, a child video, a grandchild video, etc. The tracking information can be the original tracking information generated after detecting and tacking the critical image element(s) from the parent video using the method described in the above sections, it can also be the adjusted tracking information adjusted by factors discussed in the above sections. Model 31 may further comprise programs for recognizing the identifier in the tracking information and linking the tracking information to the video file. This function of recognizing the identifier may also be performed by Module 33. Module 32 is a receiving module that receives user inputs. It can be a keypad, either a physical keypad or a displayed keypad on a touch screen that is designed to receive user inputs relating to the critical image element(s). It can also be an infrared or wireless signal receiver coupled with a decoder for receiving and interpreting user inputs relating to the critical image element(s). Module 33 is the image processing module. This module can be a microprocessor running image processing programs. Module 33 receives image video file and critical image element(s) tracking information from module 31, and user input information from module 32. It then uses user input information as a factor to adjust the tracking information, such as change the size of the critical image element(s), the brightness of the critical image element(s), etc. The adjusted tracking information is then employed to reconstruct the critical image element(s) onto the image file, and a new image file is produced. Module 33 may also comprise or be coupled to a memory unit that stores the information of an image pattern. Module 33 produces retrieving signals to retrieve such pre-stored information and produces an image pattern which can be used for reconstructing the critical image element Such retrieving signal can be triggered by user inputs, it can also be triggered by instructions embedded in the video information received from Module 31. User inputs can be used by module 33 to define or change the characteristics of the pre-stored image pattern, such as its size, color, brightness, etc. The pre-stored image pattern is then used to reconstruct the critical image element onto the image video to produce a new image video, which is then displayed by the display module 34.

According to another embodiment of the present invention, an additional element carrying certain intended information is obtained. Such additional element can be a picture, an icon, a text box, or text, or any kind of combination of the above. This additional element may change over the time. For example in the case of an advertisement, the images of the advertisement may change over the time, and in the case of a text box, the content of the text may change over the time. In a video, the additional element, the critical image element, and other image elements are presented by series of images contained in many individual image frames. The changes of these elements in a video are effected by changes of these images from frame to frame. A same element in real life, such as a baseball, can appear in different videos represented by multiple sets of images in different image frames. These images showing the same element may change from frame to frame to reflect the changes of the appearance of the element in a video. As the tracking information of a critical image element from a parent video is obtained, the images of an additional element can be added to the child video by either simply drawing to the various frames of the child video or by blending into the child video using alpha blending which is described above in connection with reconstructing the critical image element onto the child video. When adding the additional element to the child video, the positions of the images of the additional element in the image frames of the child video are calculated based on the tracking formation of the critical image element so that the additional element is dynamically presented in the video showing an interconnection between the additional element and the critical image element by way of their positional correlation. The content of the additional element can be related to the critical image element to show an even stronger interconnection between the two elements of a video. For example, the position of the additional element can have a fixed distance from the position of the critical image element in the horizontal or vertical direction, so that the additional element moves together with the critical image element in the video but their centers may not overlap. Multiple additional elements can be added to the child video based on the tracking information of one or more critical image elements.

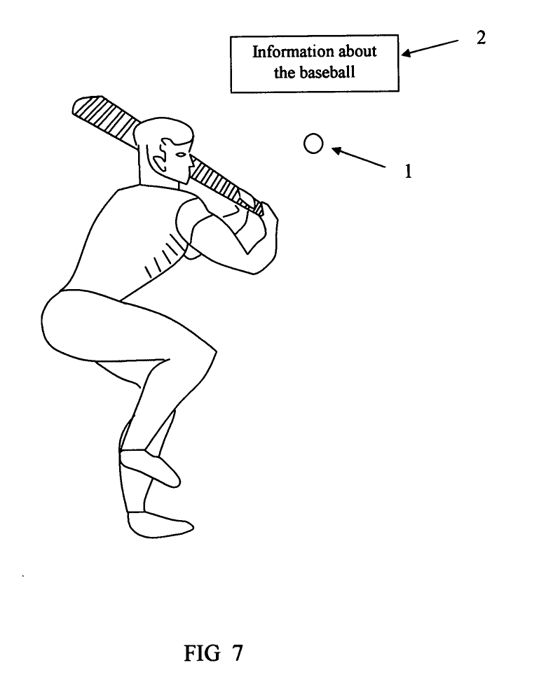

For example, in FIG. 7, an additional element 2 in the form of a text box is added to a video having an element 1 already present the video. The element 1 already present in the video is a baseball. The baseball's positional information in each particular image frame of the video is obtained using the tracking methods for a critical image element described above. The additional element 2 is added to the video by adding its images to various image frames of the video. The positions of the images of the additional element 2 in various image frames of the video are calculated based on the tracking information of element 1, so that it moves in the video with the baseball to show an interconnection between these two elements. The additional element 2 can show any information about element 1, such as its size, weight, color or speed. The text in the additional element 2, or other qualities of the images of the additional element 2, such as size, color, and brightness, may change from image frame to image frame. The additional element 2 may also just be some advertisement that does not show any specific information about element 1.

Similar to reconstructing a critical image element to the child video as discussed above, images of an additional element can be added to the child video either before the mixed video is transmitted to end users or after. In the case that the additional element is added to the child video after its image is transmitted to end users, the position of the additional element in the child video can be calculated based on a user input in addition to the tracking information or adjusted tracking information of a critical image element. In this way, the user input can be used to change the co-relationship between the additional element and the critical image element, such as their distance in the video. The user input can also be used as a factor in the calculation of a quality of an image of the additional element, such as its color, brightness, or size. Once the position of a particular image of the additional element in a particular image frame of the child video is determined, and the quality of the particular image of the additional element is calculated, this image is then added to the particular image frame of the child video. The adding process can be performed by the end user device in the same way as reconstructing the critical image element to a particular image frame of a video. As long as images of the additional element are added to sufficient number of frames of the child video using the methods described above, it will be shown in the video moving with an intended co-relationship with a certain image element already present in the video. If images of an additional element are broadcasted to an end user and mixed to a video by the end user device, these images can be carried by the video in the same manner as the tracking information of a critical image element is carried by a video as discussed above. For example, the images of an additional element can be carried by or as an auxiliary component of a video and broadcasted together with the video to an end user for mixing by the end user device.

It is obvious that there are numerous different variations and combinations of the above described embodiments of the invention. All these different variations, combinations and their equivalences are considered as part of the invention. The terms used in this description are illustrative and are not meant to restrict the scope of the invention. The described methods have steps that can be performed in different orders and yet achieve the same results. All the variations in the orders of the method steps are considered as part of this invention as long as they achieve substantially the same results. It is also well understood that image video files have multiple image frames. Different image frames of the same video can be at different processing steps at the same time. For example, some early image frames in a video may be at step 18 being displayed in front of a user, when some later image frames in the same video are still at step 15 being processed, such as in the case of a live broadcast. Event though it is one possible embodiment that all the image flames in one video is processed before the video is moved to the next step, the invention is certainly not restricted to this process. The terms video file, parent video, child video, grandchild video, great grandchild video and other similar terms are used to refer to a sequence of image frames having a certain relationship to each other. They do not have to be final electronic files saved on a medium.

The invention is further defined and claimed by the following claims.

I claim:

1. A method for displaying information comprising the steps of:
presenting a video having at least an image of a first element;
presenting a second element;
obtaining a tracking information of the first element; and
adding at least an image of the second element to the video based on the tracking information.

2. The method of claim 1 wherein the second element is a video.

3. The method of claim 1 wherein the second element is an advertisement.

4. The method of claim 1 wherein the second element is a text.

5. The method of claim 1 further comprising the steps of obtaining a user input, and changing at least one of the tracking information or a quality of the image of the second element based on the user input.

6. The method of claim 5 wherein the quality of the image of the second element comprises at least one of a color, a brightness, a content, and a size.

7. A method for displaying information comprising the steps of:
presenting a first video having at least an image of a first element;
presenting a second element;
obtaining a tracking information of the first element;
obtaining a second video having at least an image of the first element; and
adding an image of the second element to the second video based on the tracking information.

8. The method of claim 7 wherein the second video is obtained by compressing the first video.

9. The method of claim 7 wherein the second element contains information related to the first element.

10. The method of claim 7 wherein the second element is an advertisement.

11. The method of claim 7 further comprising the steps of obtaining a user input, and changing at least one of the tracking information or a quality of the image of the second element based on the user input.

12. The method of claim 11 wherein the quality of the image of the second element comprises at least one of a color, a brightness, a content, and a size.

13. A method for displaying information comprising the steps of:
presenting a first video having at least an image of a first element;
presenting a second element;
obtaining a tracking information of the first element;
obtaining a second video having at least an image of the first element; and
transmitting the tracking information, at least an image of the second element and the second video to an end user through a broadcasting network.

14. The method of claim 13 further comprising the step of adjusting the tracking information according to a comparison between the first video and the second video.

15. The method of claim 13 wherein the second element contains information related to the first element.

16. The method of claim 13 further comprising the step of incorporating at least one of the tracking information and the image of the second element into an auxiliary component of the second video.

17. The method of claim 16 wherein the auxiliary component is an auxiliary coded picture.

18. A method for displaying information comprising the steps of:
receiving a first video having at least an image of a first element;
receiving at least an image of a second element;
receiving a tracking information of the first element;
adding the image of the second element to the first video based on the tracking information to produce a second video; and
displaying the second video.

19. The method of claim 18 wherein the second element is an advertisement.

20. The method of claim 18 further comprising the steps of obtaining a user input, and changing at least one of the tracking information or a quality of the image of the second element based on the user input.
